(19) United States
(12) Patent Application Publication
(10) Pub. No.: US 2017/0017320 A1
(43) Pub. Date: Jan. 19, 2017

(54) TOUCH DISPLAY PANEL

(71) Applicant: InnoLux Corporation, Miao-Li County (TW)

(72) Inventors: Chia-Hao TSAI, Miao-Li County (TW); Chih-Hao CHANG, Miao-Li County (TW); Bo-Feng CHEN, Miao-Li County (TW); Tung-Kai LIU, Miao-Li County (TW); Jen-Chieh PENG, Miao-Li County (TW)

(21) Appl. No.: 15/203,288

(22) Filed: Jul. 6, 2016

Related U.S. Application Data
(60) Provisional application No. 62/202,570, filed on Aug. 7, 2015.
(60) Provisional application No. 62/193,787, filed on Jul. 17, 2015.

(30) Foreign Application Priority Data
Mar. 4, 2016 (TW) 105106648

(51) Int. Cl. G06F 3/044; G06F 3/041

(52) U.S. Cl. CPC G06F 3/044; G06F 3/0418; G06F 2203/04103

(57) ABSTRACT

A touch display panel includes: a common electrode; a first switching element connected between a voltage line and the common electrode; a data line transmitting a data signal during a display period and a touch sensing signal during a touch period; a pixel electrode; a second switching element connected between the data line and the pixel electrode; and a third switching element connected between the data line and the common electrode. During the display period, the first switching element and the second switching element are turned on and the third switching element is turned off. During the touch period, the first switching element and the second switching element are turned off and the third switching element is turned on.

### CROSS REFERENCE TO RELATED APPLICATIONS

This application claims the benefit of U.S. Provisional Application No. 62/193,787, filed on Jul. 17, 2015, and U.S. Provisional Application No. 62/202,570, filed on Aug. 7, 2015, the entirety of which is incorporated by reference herein.

This Application claims priority of Taiwan Patent Application No. 105106648, filed on Mar. 4, 2016, the entirety of which is incorporated by reference herein.

### BACKGROUND OF THE INVENTION

Field of the Invention

The disclosure relates to a touch display panel, and in particular to a touch display panel using data lines to transmit touch sensing signals.

Description of the Related Art

The touch display panel is a new type of display panel that integrates the display function and the touch function. In a conventional touch display panel, the common electrode is divided into a plurality of electrode blocks which are arranged in a matrix. Each electrode block is used as a normal common electrode in the display period and as a touch sensing electrode in the touch period. The position of a touch object is determined by detecting the capacitance formed between the touch sensing electrode and the touch object.

The electrode blocks which are arranged in a matrix are connected to a driving chip via respective metal wires. Those metal wires are formed with the third metal layer in the manufacturing process. The third metal layer is formed on a passivation layer above the first metal layer which includes gate lines and the second metal layer which includes data lines. With this design, the driving chip needs many output pins, and the wire layout between the driving chip and the display area spreads out in a fan shape, occupying much space. Furthermore, the difference in the length of those metal wires is so big that the image is displayed non-uniformly. If the area of the driving chip is not increased, there may be no space to provide enough output pins and a high precision touch function cannot be implemented. If the area of the driving chip is increased, the edge of the glass substrate bonded with the driving chip in a heat bonding process may be bent due to heat expansion. Furthermore, the manufacturing process requires many steps to form the metal wires of the third metal layer, which increases the manufacturing cost. In addition, the third metal layer is formed above a planarization layer, so the metal wire that came from the driving chip has to extend upwardly to reach the third metal layer. It is easy to cause wire breakage or short circuit with other electrodes. Therefore, the yield rate of the touch display panel is decreased. Finally, it is easy to generate coupling capacitance between the metal wire and other circuits. The coupling capacitance makes crosstalk of signals and hence influences the accuracy of touch sensing.

In view of the above problems, the disclosure provides a touch display panel which doesn't use the metal wires of the third layer.

### BRIEF SUMMARY OF THE INVENTION

A detailed description is given in the following embodiments with reference to the accompanying drawings.

The disclosure provides a touch display panel, including: a common electrode; a first switching element connected between a voltage line and the common electrode; a data line transmitting a data signal during a display period and a touch sensing signal during a touch period; a pixel electrode; a second switching element connected between the data line and the pixel electrode; and a third switching element connected between the data line and the common electrode. During the display period, the first switching element and the second switching element are turned on and the third switching element is turned off. During the touch period, the first switching element and the second switching element are turned off and the third switching element is turned on.

In the above touch display panel, the first switching element is controlled by a first control signal and the third switching element is controlled by a second control signal, and the first control signal and the second control signal are substantially out of phase.

In the above touch display panel, the second switching element is controlled by a gate signal, and the pulse edge of the first and second control signals can be adjusted earlier or later, and the adjustable range is within a width of 10 pulses of the gate signal.

In the above touch display panel, the second and third switching elements are disposed in the area of the common electrode, and the first switching element is disposed outside the area of the common electrode and connected to the common electrode via a common electrode line.

According to an embodiment, the above touch display panel further includes: a driving chip. The driving chip includes: an output terminal connected to the data line; a data signal buffer storing the data signal; a touch sensing signal buffer storing the touch sensing signal; and a switch connecting the data signal buffer with the output end during the display period and connecting the touch sensing signal buffer with the output end during the touch period.

According to another embodiment, the above touch display panel further includes: a driving chip and a fourth switching element. The driving includes: a data signal output terminal connected to the data line for outputting the data signal; and a touch sensing signal output terminal for outputting the touch sensing signal, wherein the fourth switching element is connected between the data line and the touch sensing signal output terminal. During the display period, the fourth switching element is turned off and the data signal output terminal outputs the data signal to the data line. During the touch period, the fourth switching element is turned on, the touch sensing signal output terminal outputs the touch sensing signal to the data line via the fourth switching element, and the data signal output terminal is floating.

In the above touch display panel, the first switching element is controlled by a first control signal and the third and fourth switching element are controlled by a second control signal, and the first control signal and the second control signal are substantially out of phase. The second switching element is controlled by a gate signal, and the pulse edge of the first and second control signals can be adjusted earlier or later, and the adjustable range is within a width of 10 pulses of the gate signal.

In the above touch display panel, the second and third switching elements are disposed in the area of the common electrode. The first and fourth switching element are disposed outside the area of the common electrode and the first switching element is connected to the common electrode via a common electrode line.

According to another embodiment, the above touch display panel further includes: a driving chip. The driving chip includes: a data signal output terminal connected to the data line for outputting the data signal; and a touch sensing signal output terminal for outputting the touch sensing signal. During the display period, the data signal output terminal outputs the data signal to the data line and the touch sensing signal output terminal is floating. During the touch period, the touch sensing signal output terminal outputs the touch sensing signal to the data line and the data signal output terminal is floating.

According to the embodiments, the disclosure provides a touch display panel using data lines to transmit touch sensing signals. With this structure, the number of manufacturing steps is decreased, the manufacturing cost is reduced, the aperture ratio is increased, the yield is raised, non-uniform image display is prevented, and signal crosstalk is decreased.

### BRIEF DESCRIPTION OF THE DRAWINGS

The disclosure can be more fully understood by reading the subsequent detailed description and examples with references made to the accompanying drawings, wherein:

FIG. 1 is a schematic top view of a touch display panel in accordance with Embodiment 1 of the disclosure;

FIG. 2 is an equivalent circuit diagram showing the features of the four areas shown in FIG. 1;

FIG. 3A is a top view of the first switching element in the area 1;

FIG. 3B is a cross-sectional view from A-A′ line shown in FIG. 3A;

FIG. 4A is a top view of the second and third switching elements in the area 2;

FIG. 4B is a cross-sectional view from B-B′ line shown in FIG. 4A;

FIG. 5A is a top view of the second switching element and a contact hole between the common electrode line and the common electrode in the area 3;

FIG. 5B is a cross-sectional view from C-C′ line shown in FIG. 5A;

FIG. 6A is a top view of the second switching element in the area 4;

FIG. 6B is cross-sectional view from D-D′ line shown in FIG. 6A;

FIG. 7A is an inner structure of a driving chip in accordance of Embodiment 1 of the disclosure;

FIG. 7B is an inner structure of a driving chip in accordance of Embodiment 1 of the disclosure;

FIG. 8A is an equivalent circuit diagram of the circuit of FIG. 2 operating in a display period;

FIG. 8B is an equivalent circuit diagram of the circuit of FIG. 2 operating in a touch period;

FIG. 9 is a waveform diagram of operating voltages for the touch display panel in accordance of Embodiment 1 of the disclosure;

FIG. 10 is a schematic top view of a touch display panel in accordance with Embodiment 2 of the disclosure;

FIG. 11 is an equivalent circuit diagram showing the features of multiple areas shown in FIG. 10;

FIG. 12A is an equivalent circuit diagram of the circuit of FIG. 11 operating in a display period;

FIG. 12B is an equivalent circuit diagram of the circuit of FIG. 11 operating in a touch period;

FIG. 13 is a waveform diagram of operating voltages for the touch display panel in accordance of Embodiment 2 of the disclosure;

FIG. 14 is a schematic top view of a touch display panel in accordance with Embodiment 3 of the disclosure;

FIG. 15 is an equivalent circuit diagram showing the features of multiple areas shown in FIG. 14;

FIG. 16A is an equivalent circuit diagram of the circuit of FIG. 15 operating in a display period;

FIG. 16B is an equivalent circuit diagram of the circuit of FIG. 15 operating in a touch period; and

FIG. 17 is a waveform diagram of operating voltages for the touch display panel in accordance of Embodiment 3 of the disclosure.

### DETAILED DESCRIPTION OF THE INVENTION

The following description is of the contemplated mode of carrying out the disclosure. This description is made for the purpose of illustrating the general principles of the disclosure and should not be taken in a limiting sense. The scope of the disclosure is determined by reference to the appended claims.

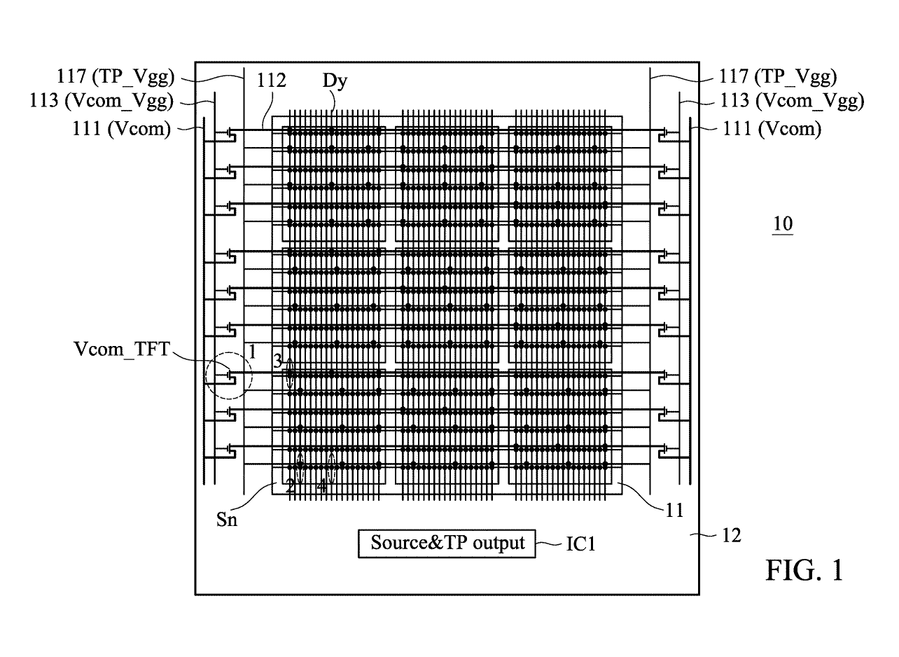

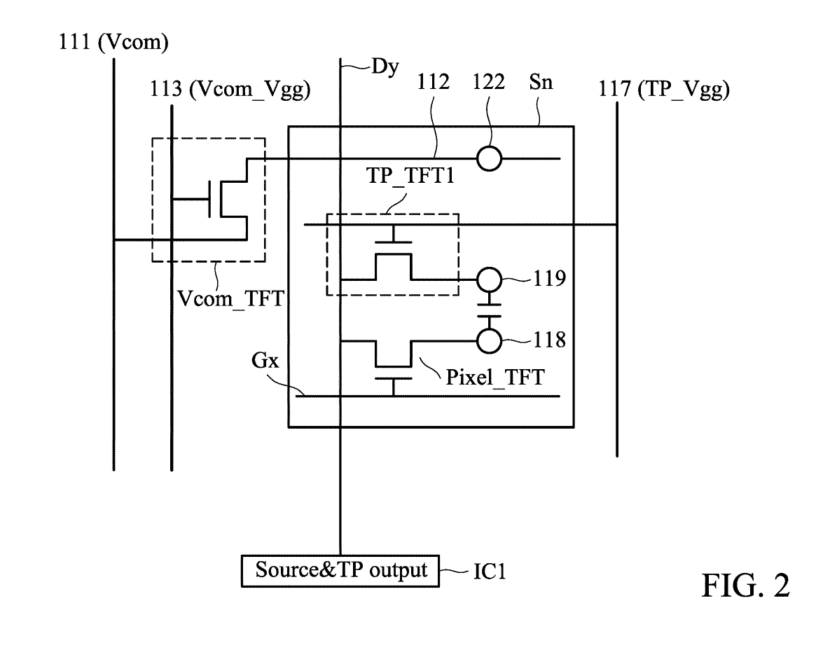

FIG. 1 is a schematic top view of a touch display panel in accordance with Embodiment 1 of the disclosure. The touch display panel 10 shown in FIG. 1 has a display area 11 and a peripheral area 12 surrounding the display area 11. There are 9 (the number is merely an example) common electrodes (or touch electrodes) Sn. A driving chip IC1 is disposed on the peripheral area 12 and connects with pixels arranged on each pixel columns via data lines Dy. The features of the disclosure can be understood form FIG. 1 by observing four areas respectively labeled with 1˜4. FIG. 2 is an equivalent circuit diagram showing the features of the four areas shown in FIG. 1.

There are first switching elements Vcom_TFT disposed at the left and right sides of the peripheral area 12. An end of the first switching elements Vcom_TFT is connected to a wire 111 supplying a common voltage level Vcom, and the other end is connected to a common electrode line 112. The common electrode line 112 extends in the row direction and coupled to one common electrode Sn. The control terminal of the first switching elements Vcom_TFT is connected to a wire 113 supplying a first control signal Vcom_vgg. The level of the first control signal Vcom_vgg controls the conduction of the first switching elements Vcom_TFT to select whether or not to supply the common voltage level Vcom to the common electrode line 112.

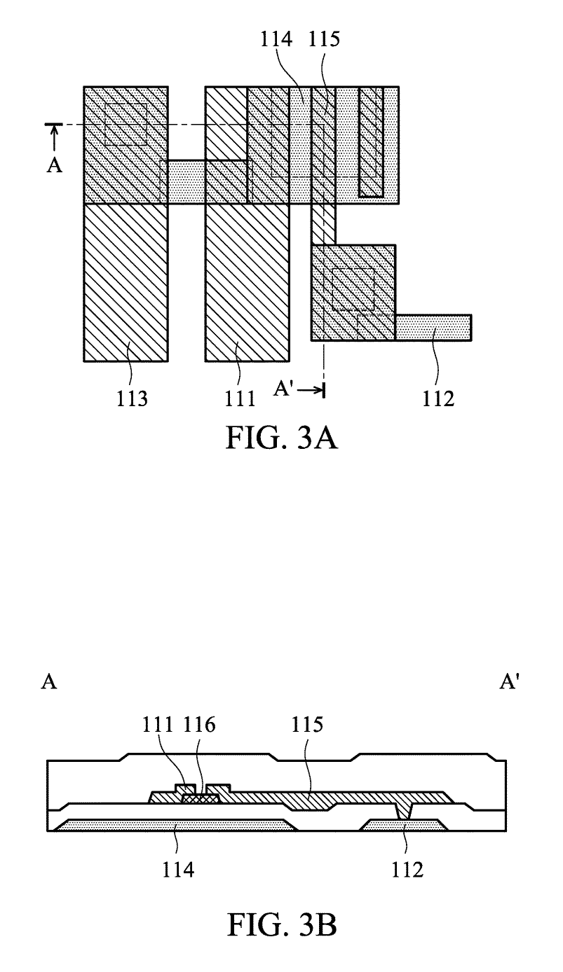

FIG. 3A is a top view of the first switching element Vcom_TFT in the area 1. FIG. 3B is a cross-sectional view from A-A′ line shown in FIG. 3A. The element sign 114 is the gate of the first switching element Vcom_TFT, which is formed with the first metal layer as the common electrode line 112 is. The element sign GI is a gate insulating layer. The wire 111 providing the common voltage level Vcom is connected to the drain (or source) of the first switching element Vcom_TFT. The element sign 115 is a metal wire of the source (or drain) of the first switching element Vcom_TFT, which is formed with the second metal layer as the common electrode line 111 is. The source (or drain) metal wire 115 is coupled to the common electrode line 112 located on the first metal layer via a contact hole. The element sign 116 is an active layer (tunnel) of the first switching element Vcom_TFT. The element sign BP1 is a passivation layer which covers the entire first switching element Vcom_TFT.

One common electrode (or touch electrode) Sn is shared by a plurality of pixels. Each pixel has a pixel electrode 118 and a second switching element Pixel_TFT. The second switching element Pixel_TFT is connected between a pixel electrode 118 and a data line Dy. The second switching element Pixel_TFT is conducted by the control of a gate line Gx transmitting a gate signal. Therefore, the data signal transmitted by the data line is written to the pixel electrode 118. At least one (FIG. 1 shows nine pixels) of those pixels further has a third switching element TP_TFT1. The third switching element TP_TFT1 is connected between the data line Dy and the common electrode (or touch electrode) Sn. The third switching element TP_TFT1 is conducted by the control of the wire 117 supplying a second control signal TP_vgg. Therefore, the touch sensing signal transmitted by the data line is sent to the common electrode (or touch electrode) Sn to perform touch sensing operations.

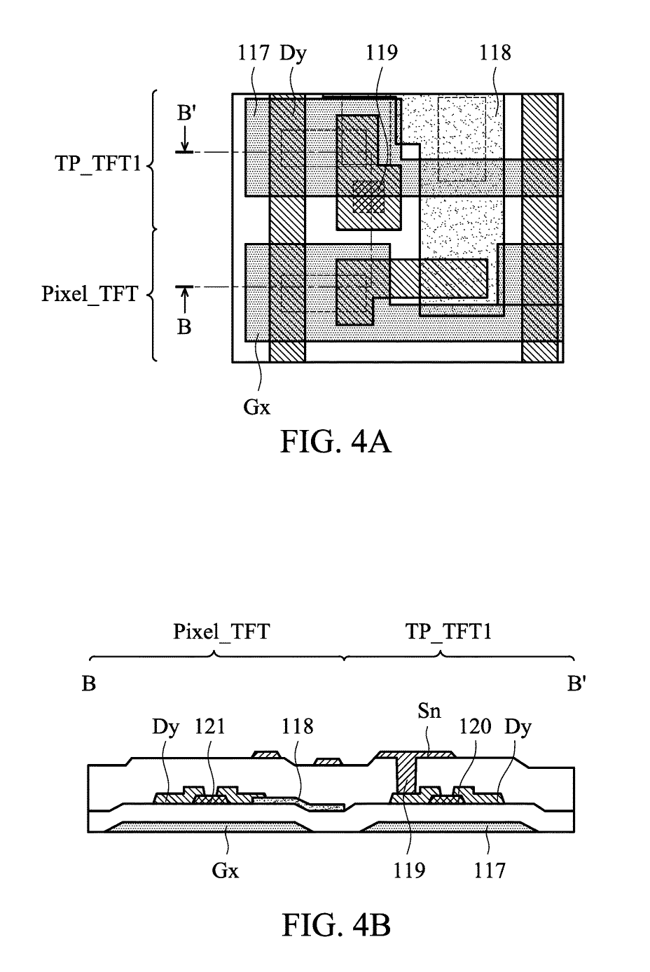

FIG. 4A is a top view of the second switching element Pixel_TFT and the third switching elements TP_TFT1 in the area 2. FIG. 4B is a cross-sectional view from B-B′ line shown in FIG. 4A. The wire 117 supplying the second control signal TP_vgg and the gate line Gx are formed with the first metal layer. The data line Dy and the pixel electrode 118 which are respectively connected to the two ends of the second switching element Pixel_TFT are formed with the second metal layer. The element sign 121 is an active layer (tunnel) of the second switching element Pixel_TFT. The drain (or source) of the third switching element TP_TFT1 is connected to the data line Dy. The source (or drain) of the third switching element TP_TFT1 is connected to the common electrode (or touch electrode) Sn via a contact hole 119. The common electrode (or touch electrode) Sn is formed on a passivation layer BP1 which covers the entire second switching element Pixel_TFT and the third switching element TP_TFT.

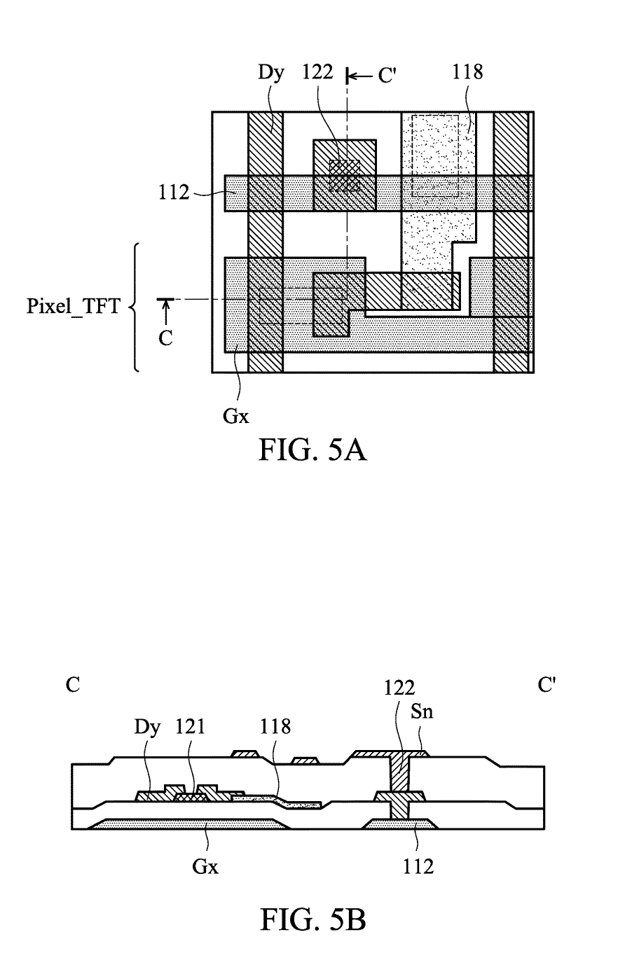

The area 3 is an area where the common electrode line 112 is connected to the common electrode (or touch electrode) Sn via the contact hole 122. FIG. 5A is a top view of the second switching element Pixel_TFT and the contact hole 122 located between the common electrode line 112 and the common electrode Sn in the area 3. FIG. 5B is a cross-sectional view from C-C′ line shown in FIG. 5A. The portion of the second switching element Pixel_TFT is the same as that shown in the area 2, so the description is not repeated. As shown in FIGS. 5A and 5B, the area 3 shows that the common electrode line 112 passes through a pixel and there is the contact hole 122 connecting the common electrode line 112 located on the first metal layer and the common electrode (or touch electrode) Sn located on the third metal layer. Therefore, the common voltage level Vcom supplied by the common electrode line 112 can be supplied to the common electrode (or touch electrode) Sn.

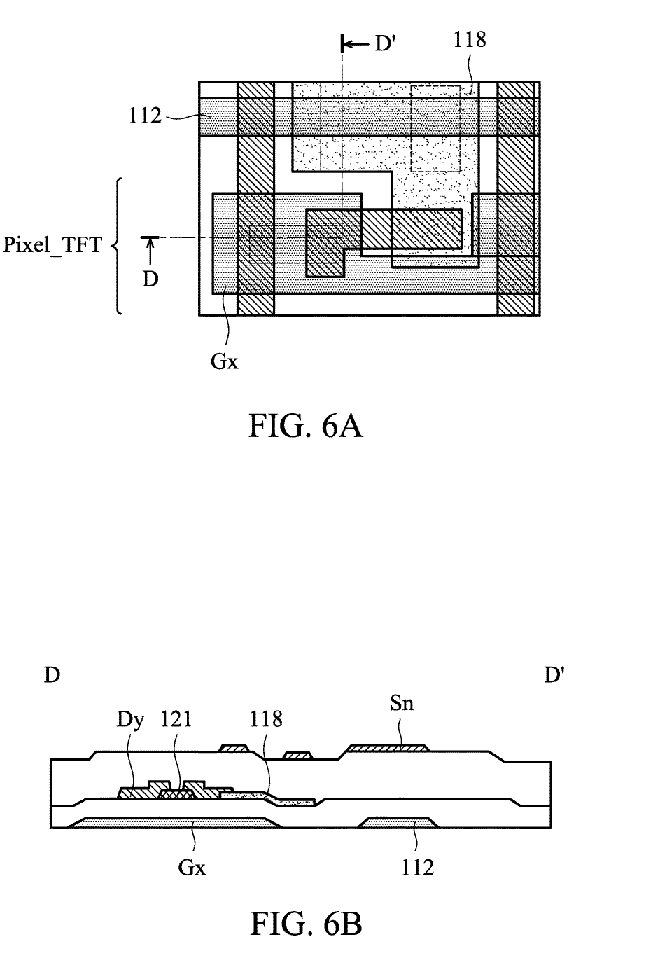

The area 4 is an area where neither the third switching element TP_TFT1 nor the contact hole exists in the pixel. FIG. 6A is a top view of the second switching element Pixel_TFT in the area 4. FIG. 6B is cross-sectional view from D-D′ line shown in FIG. 6A. the second switching element Pixel_TFT is the same as shown in the area 2 and the area 3, so the description is not repeated. As shown in FIGS. 6A and 6B, the area 4 shows that the common electrode line 112 passes through a pixel, but there is no contact hole disposed in that pixel.

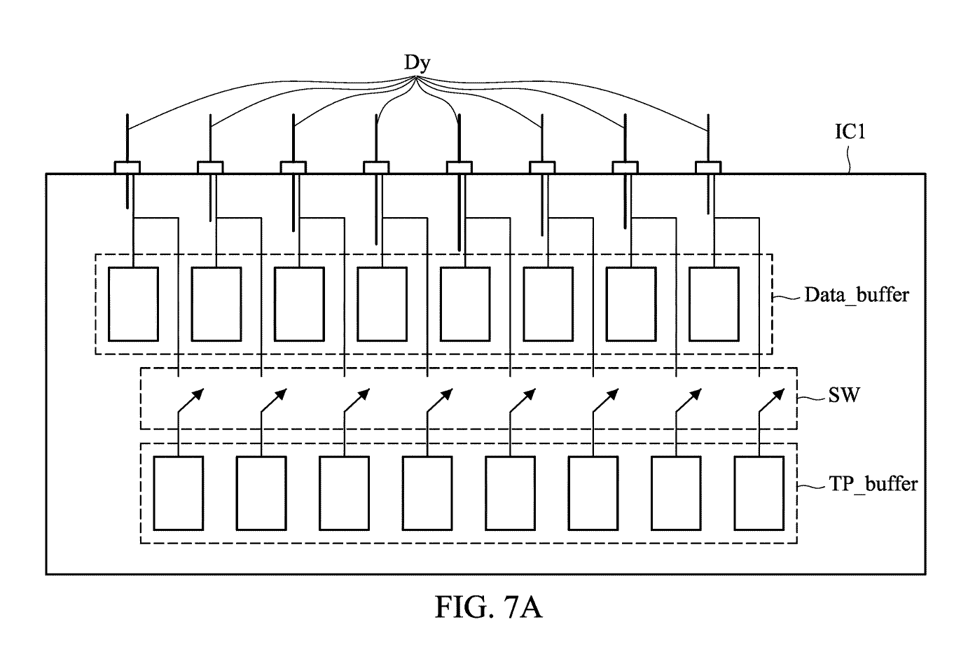

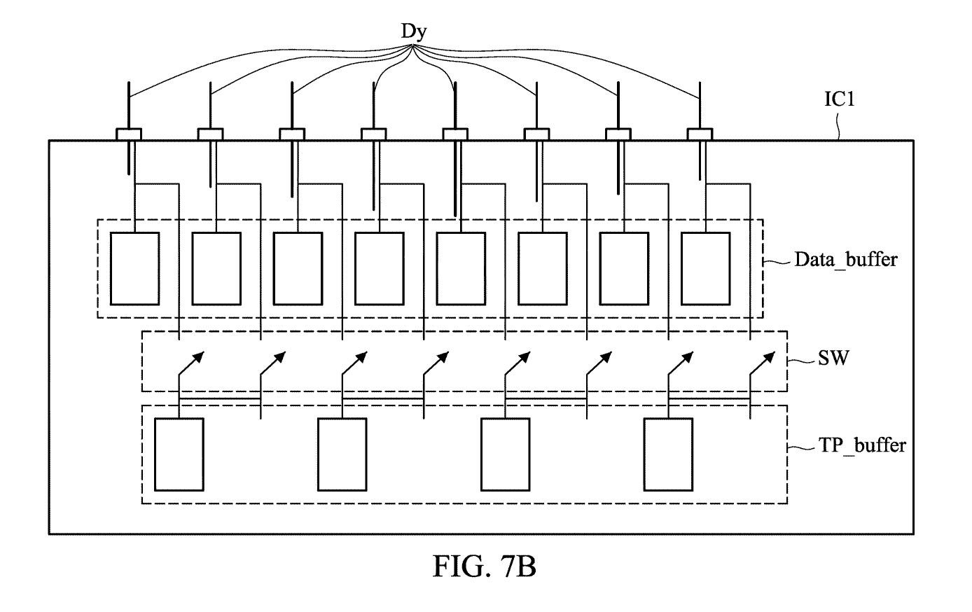

In Embodiment 1 of the disclosure, the driving chip IC1 provides the data signal and the touch sensing signal to the data line Dy via the same output terminal (channel). FIGS. 7A and 7B are two inner structures of the driving chip IC1 in accordance of Embodiment 1 of the disclosure. In FIG. 7A, the driving chip IC1 has a plurality of output terminals connected to a plurality of data lines Dy. The driving chip IC1 has a plurality of data signal buffers Data_buffer and touch sensing signal buffers TP_buffer. The number of data signal buffers Data_buffer and the number of touch sensing signal buffers TP_buffer are the same as the number of output terminals. Each data signal buffer Data_buffer is connected to an output terminal so as to send the stored data signal to a data line Dy. Each touch sensing signal buffer TP_buffer is connected to an output terminal through a switch SW so as to send the stored touch sensing signal to a data line Dy. During the display period, the switch SW is switched off so that only the data signal buffer Data_buffer can output the data signal. During the touch period, the switch SW is switched on so that the touch sensing signal buffer TP_buffer can output the touch sensing signal, while the operation of the data signal buffer Data_buffer is paused. In FIG. 7B, the difference from FIG. 7A is that the number of touch sensing signal buffers TP_buffer is less than the number of output terminals (or data lines Dy). Because the channels for transmitting the touch sensing signal are not required as many as the channels for transmitting the data signal, one touch sensing signal buffers TP_buffer can send touch sensing signals to at least two data lines Dy by an one-to-many switch SW.

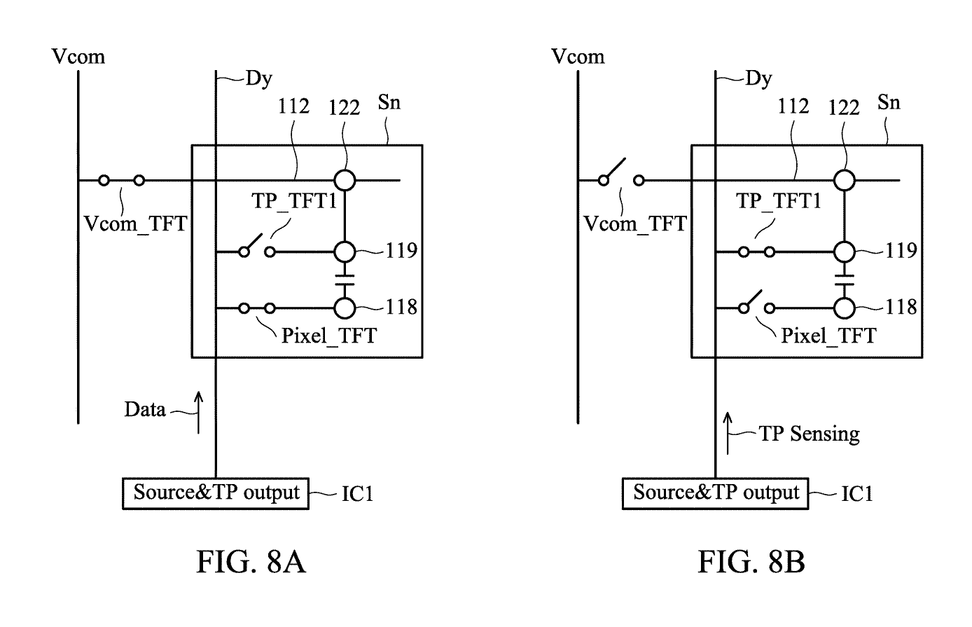

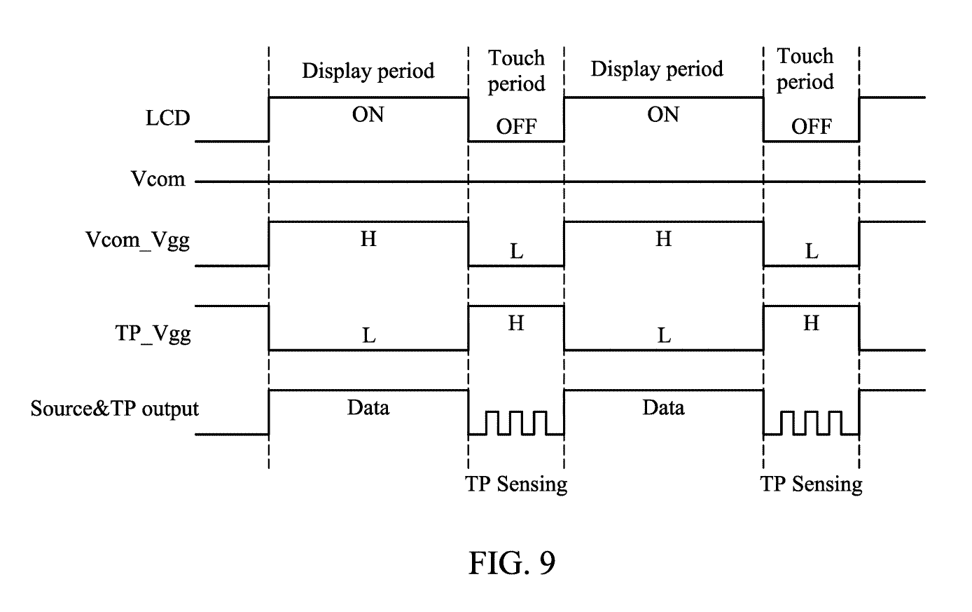

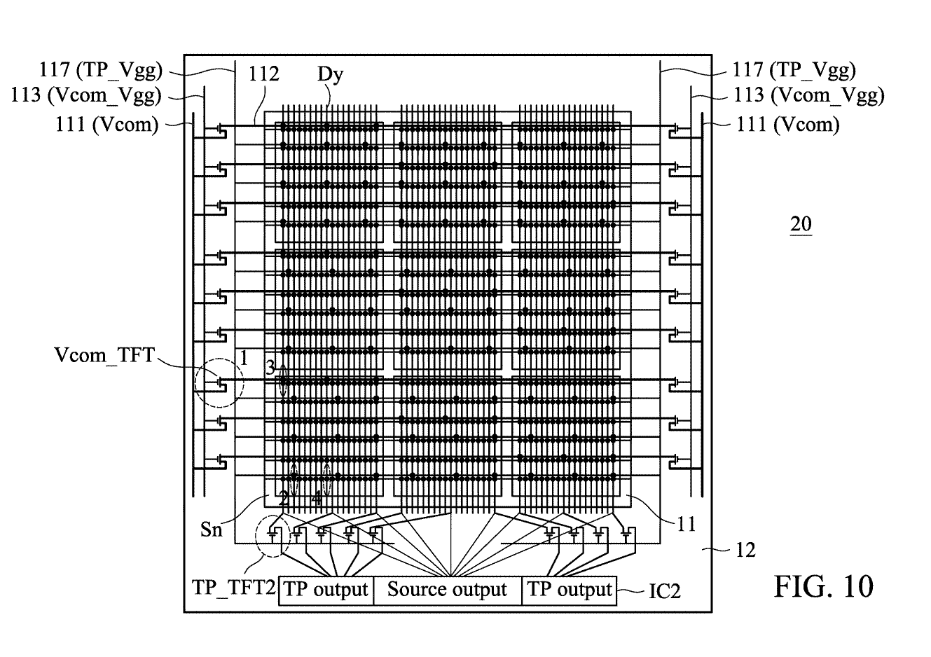

Following, the operation of the touch display panel of Embodiment 1 is described. FIG. 8A is an equivalent circuit diagram of the circuit of FIG. 2 operating in a display period. FIG. 8B is an equivalent circuit diagram of the circuit of FIG. 2 operating in a touch period. FIG. 9 is a waveform diagram of operating voltages for the touch display panel in accordance of Embodiment 1 of the disclosure. As shown in FIGS. 8A and 9, during the display period, the status of the display panel (represented by reference sign LCD) is on, which indicates that the display panel is operating. The first control signal Vcom_vgg is at the high level H to turn on the first switching element Vcom_TFT and the common voltage level Vcom is output from the common electrode line 112 to the common electrode (or touch electrode) Sn. At the mean time the second control signal TP_vgg is at low level L to turn off the third switching element TP_TFT1. Therefore, the common electrode (or touch electrode) Sn is at the common voltage level Vcom. During the display period, the data line Dy sends out the data signal DATA, the gate line Gx sends out the gate signal to turn on the second switching element Pixel_TFT of the pixel, and thus the data signal DATA is written to the pixel electrode 118. As shown in FIGS. 8B and 9, during the touch period, the status of the display panel (represented by reference sign LCD) is off, which indicates that the display panel stops operating. The first control signal Vcom_vgg is at the low level L to turn off the first switching element Vcom_TFT and the common electrode (or touch electrode) Sn is isolated from the common voltage level Vcom. At the meantime the second control signal TP_vgg is at the high level H to turn on the third switching element TP_TFT1. During the touch period, the data line Dy sends out the touch sensing signal TP_Sensing, and the touch sensing signal TP_Sensing reaches the common electrode (or touch electrode) Sn via the third switching element TP_TFT1 to perform touch sensing operations. The gate line Gx sends out the gate signal to turn off the second switching element Pixel_TFT of the pixel, so that the pixel electrode 118 is floating.

Note that in FIG. 9 the first control signal Vcom_vgg and the second control signal TP_vgg is out of phase completely. Namely. The falling (rising) edge of the first control signal Vcom_vgg and the rising (falling) edge of the second control signal TP_vgg occur at the same time point. However, under design, the falling (rising) edge of the first control signal Vcom_vgg and the rising (falling) edge of the second control signal TP_vgg can be adjusted earlier or later to meet various considerations of practical situation. The two signals don't have to be out of phase completely. The high-level periods of the two signals can be overlapped or not be overlapped. Specifically, the falling (rising) edge of the first control signal Vcom_vgg and the rising (falling) edge of the second control signal TP_vgg can be adjusted earlier or later within a width of 10 pulses of the gate signal.

In addition, the length ratio between the display period and the touch period doesn't represent their actual time ratio. The disclosure doesn't limit the driving scheme for the display period and the touch period. For example, a display period can last long enough to display a complete image and then be switched to a touch period. It is also possible that a display period lasts only for displaying a portion of an image and then is switched to a touch period. The other portions of the image are displayed during the following display periods.

According to the touch display panel of Embodiment 1 of the disclosure, by the arrangement of the first switching element Vcom_TFT and the third switching element TP_TFT1, the driving chip IC1 can send the touch sensing signals through the data line Dy located on the second metal layer. Therefore, it is not necessary to transmit the touch sensing signals through the metal wires located on the third metal layer as the conventional art. The problems due to the metal wire made of the third metal layer can be solved. The number of manufacturing steps is decreased, the manufacturing cost is reduced, the aperture ratio is increased, the yield is raised, non-uniform image display is prevented, and signal crosstalk is decreased.

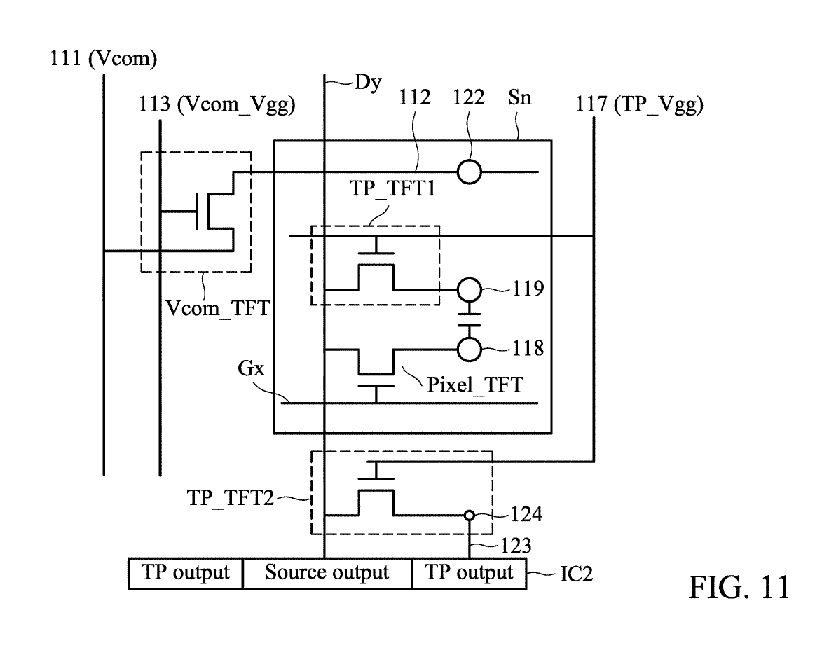

FIG. 10 is a schematic top view of a touch display panel in accordance with Embodiment 2 of the disclosure. In the touch display panel 20 shown in FIG. 10, the output terminal (channel) of the driving chip IC2 is different from the driving chip IC1. There is a fourth switching element TP_TFT2 disposed between the output terminal of the driving chip IC2 and the data line Dy. The other features of the touch display panel 20 are the same as the touch display panel 10. The detailed features of the touch display panel 20 are shown in FIG. 11.

FIG. 11 is an equivalent circuit diagram showing the features of multiple areas shown in FIG. 10. In Embodiment 2, the driving chip IC2 includes two portions: a data signal output portion (the part labeled “Source output” in FIG. 11) and a touch sensing signal portion (the part labeled “TP output” in FIG. 11). The data signal output portion has output terminals for outputting the data signals, the number of which is the same as the number of data lines. The touch sensing signal portion has fewer output terminals for outputting the touch sensing signals. A fourth switching element TP_TFT2 is disposed between a wire (the data line Dy) connected to the output terminal of the data signal output terminal and a wire 123 connected to the output terminal of the touch sensing signal portion. The fourth switching element TP_TFT2 is conducted by, for example, the control of the wire 117 supplying the second control signal TP_vgg. When the fourth switching element TP_TFT2 is conducted, the touch sensing signals output from the touch sensing signal output portion are transmitted to the data line Dy. When the fourth switching element TP_TFT2 is non-conducted, the data signals output from the data signal output portion are transmitted to the data line Dy. Note that the wire 123 can be made of any one of the first metal layer, the second metal layer, and the third metal layer. If the wire 123 is not located on the second metal layer where the data line Dy is located, the wire 123 may be coupled to the second metal layer via a contact hole 124 and then connected to the fourth switching element TP_TFT2. The fourth switching element TP_TFT2 can be disposed anywhere close to the lower boundary.

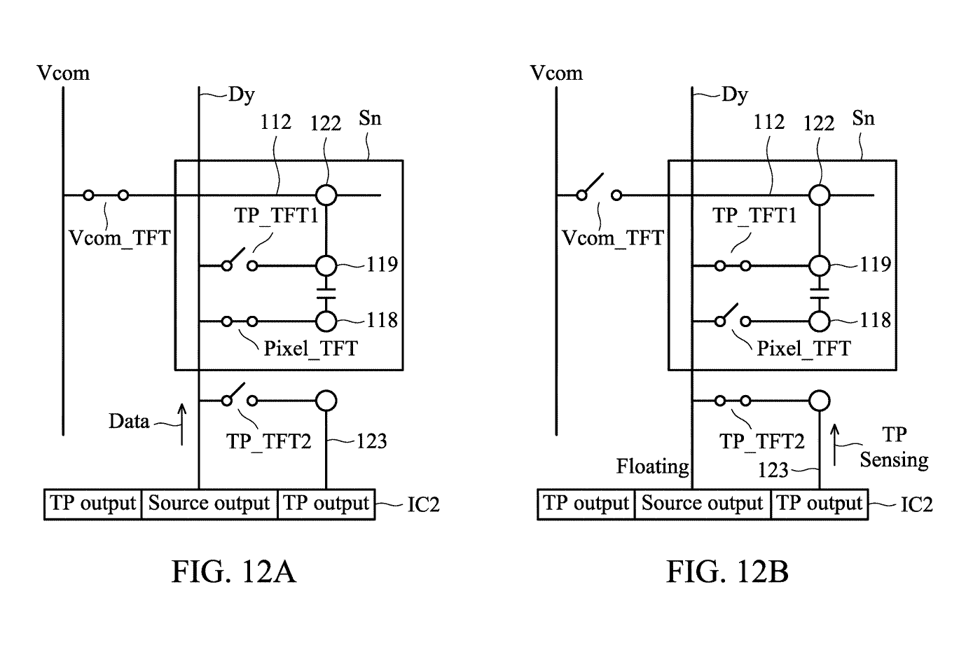

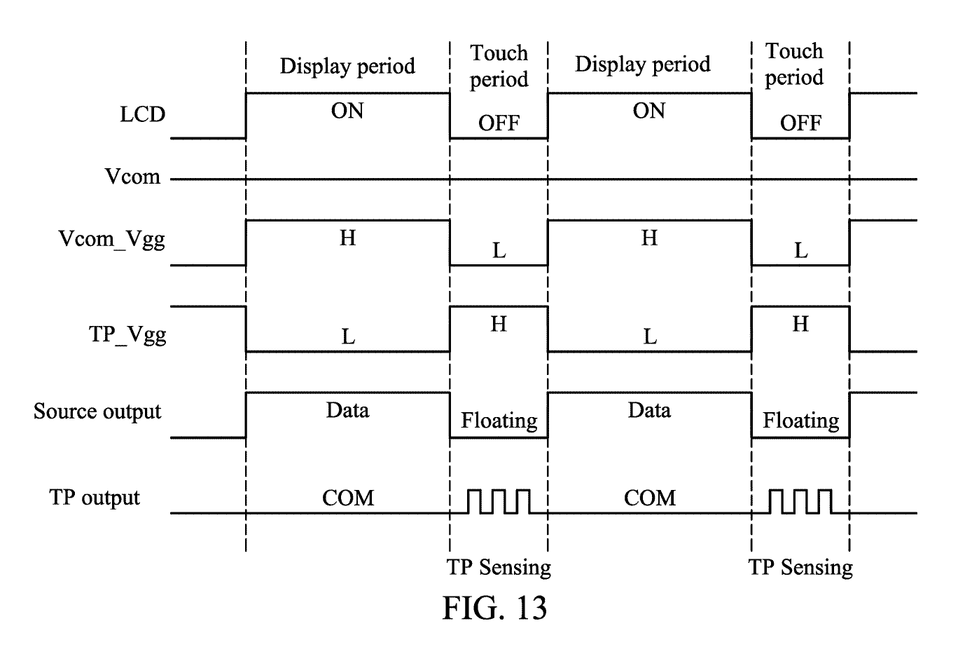

Following, the operation of the touch display panel of Embodiment 2 is described. FIG. 12A is an equivalent circuit diagram of the circuit of FIG. 11 operating in a display period. FIG. 12B is an equivalent circuit diagram of the circuit of FIG. 11 operating in a touch period. FIG. 13 is a waveform diagram of operating voltages for the touch display panel in accordance of Embodiment 2 of the disclosure. As shown in FIGS. 12A and 13, during the display period, the status of the display panel (represented by reference sign LCD) is on, which indicates that the display panel is operating. The first control signal Vcom_vgg is at the high level H to turn on the first switching element Vcom_TFT and the common voltage level Vcom is output from the common electrode line 112 to the common electrode (or touch electrode) Sn. At the mean time the second control signal TP_vgg is at the low level L to turn off the third switching element TP_TFT1 and the fourth switching element TP_TFT2. Therefore, the common electrode (or touch electrode) Sn is at the common voltage level Vcom. The data line Dy is isolated from the output terminal of the touch sensing signal output portion. During the display period, the data line Dy sends out the data signal DATA, the gate line Gx sends out the gate signal to turn on the second switching element Pixel_TFT of the pixel, and thus the data signal DATA is written to the pixel electrode 118. As shown in FIGS. 12B and 13, during the touch period, the status of the display panel (represented by reference sign LCD) is off, which indicates that the display panel stops operating. The first control signal Vcom_vgg is at the low level L to turn off the first switching element Vcom_TFT and the common electrode (or touch electrode) Sn is isolated from the common voltage level Vcom. At the mean time the second control signal TP_vgg is at the high level H to turn on the third switching element TP_TFT1 and the fourth switching element TP_TFT2. During the touch period, the touch sensing signal output portion sends out the touch sensing signal TP_Sensing to the data line Dy via the fourth switching element TP_TFT2, and the touch sensing signal TP_Sensing reaches the common electrode (or touch electrode) Sn via the third switching element TP_TFT1 to perform touch sensing operations. At the meantime, the output terminal of the data signal output portion is floating. In addition, the gate line Gx sends out the gate signal to turn off the second switching element Pixel_TFT of the pixel, so that the pixel electrode 118 is floating.

Similar to Embodiment 1, the first control signal Vcom_vgg and the second control signal TP_vgg don't have to be out of phase completely. The high-level periods of the two signals can be overlapped or not be overlapped. Specifically, the falling (rising) edge of the first control signal Vcom_vgg and the rising (falling) edge of the second control signal TP_vgg can be adjusted earlier or later within a width of 10 pulses of the gate signal.

According to the touch display panel of Embodiment 2 of the disclosure, a driving chip having respective terminals (channels) for output the data signal and touch sensing signal is utilized, and a fourth switching element is disposed between the driving chip and the data line. Embodiment 2 can achieve effects as the same as Embodiment 1 does.

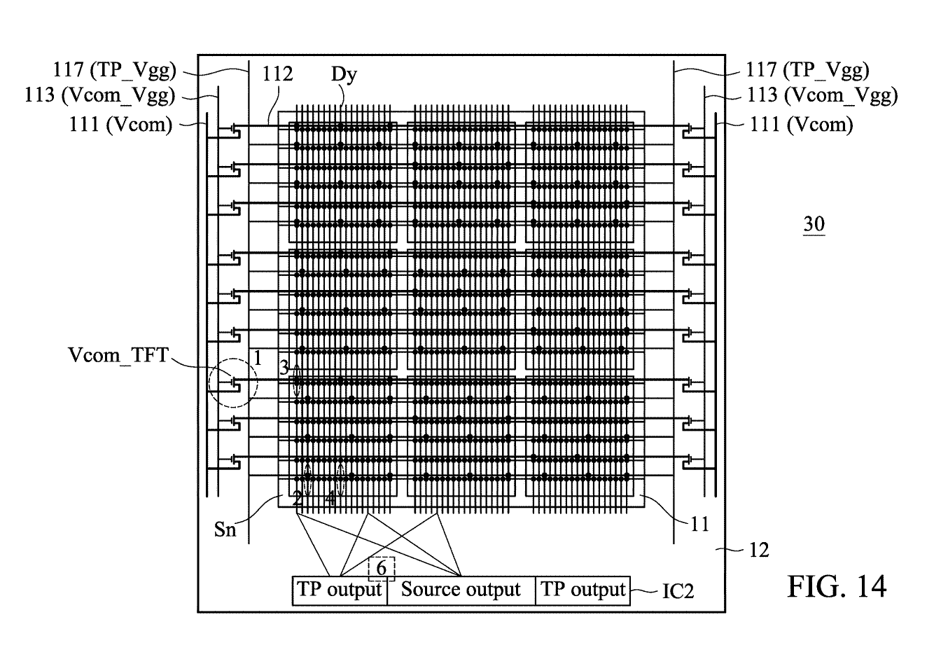

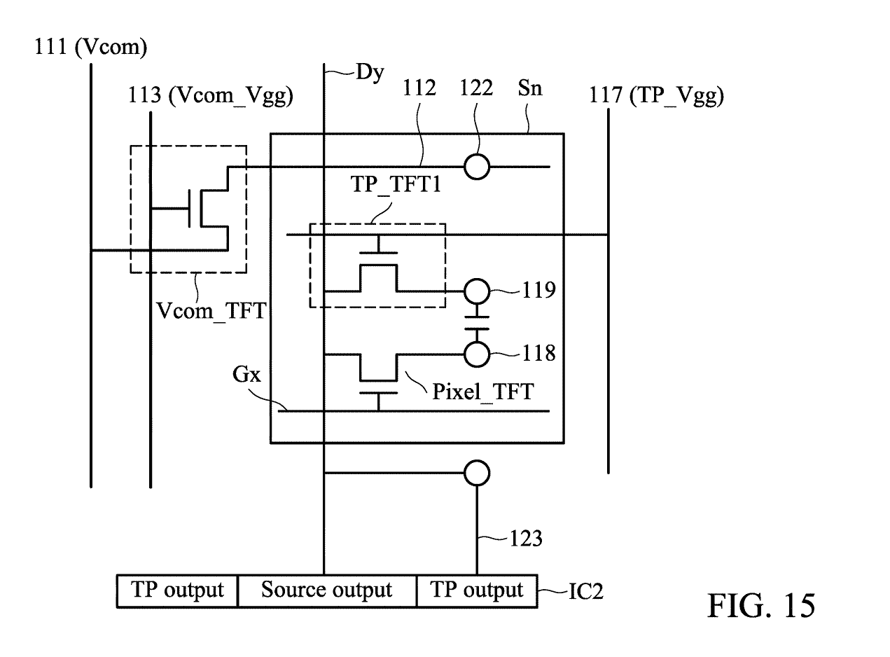

FIG. 14 is a schematic top view of a touch display panel in accordance with Embodiment 3 of the disclosure. In the touch display panel 30 shown in FIG. 14, There is not a fourth switching element TP_TFT2 disposed between the output terminal of the driving chip IC2 and the data line Dy. The other features of the touch display panel 30 are the same as the touch display panel 20 of Embodiment 2. The detailed features of the touch display panel 30 are shown in FIG. 15.

FIG. 15 is an equivalent circuit diagram showing the features of multiple areas shown in FIG. 14. In Embodiment 3, the driving chip IC2 includes two portions: a data signal output portion (the part labeled “Source output” in FIG. 14) and a touch sensing signal portion (the part labeled “TP output” in FIG. 14). The data signal output portion has output terminals for outputting the data signals, the number of which is the same as the number of data lines. The touch sensing signal portion has fewer output terminals for outputting the touch sensing signals. There is not a fourth switching element TP_TFT2. The output signals form the data signal output portion and the touch sensing signal output portion are directly controlled. Similar to Embodiment 2, the wire 123 can be made of any one of the first metal layer, the second metal layer, and the third metal layer. If the wire 123 is not located on the second metal layer where the data line Dy is located, the wire 123 may be coupled to the second metal layer via a contact hole 124.

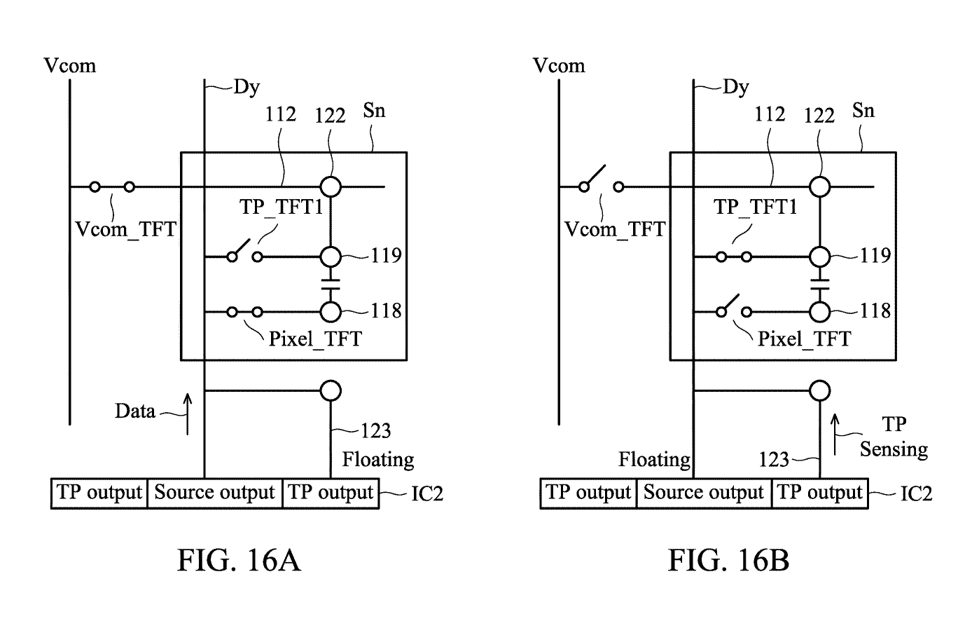

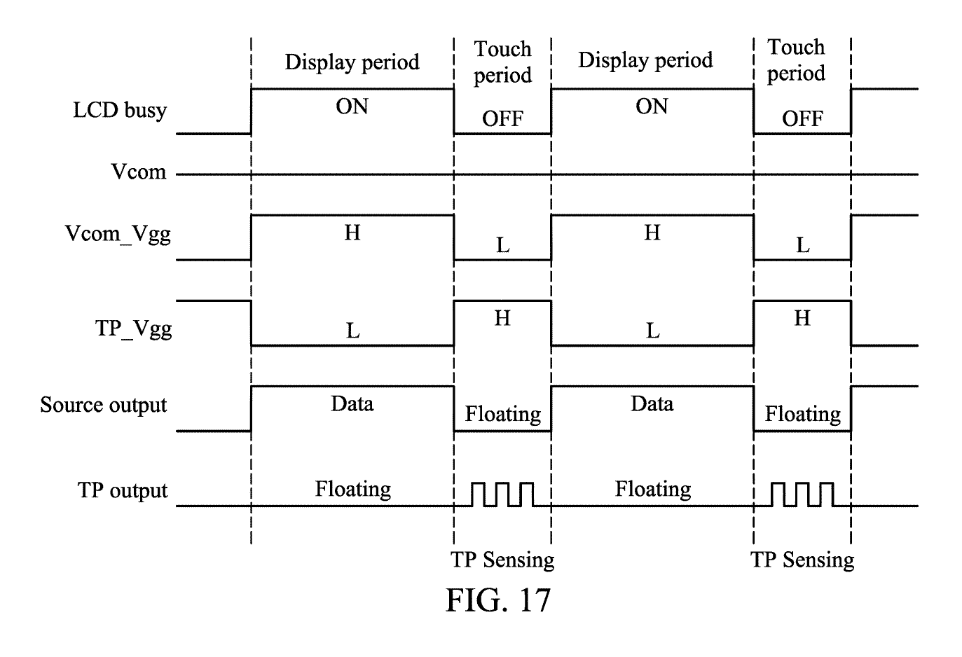

Following, the operation of the touch display panel of Embodiment 3 is described. FIG. 16A is an equivalent circuit diagram of the circuit of FIG. 15 operating in a display period. FIG. 16B is an equivalent circuit diagram of the circuit of FIG. 15 operating in a touch period. FIG. 17 is a waveform diagram of operating voltages for the touch display panel in accordance of Embodiment 3 of the disclosure. As shown in FIGS. 16A and 17, during the display period, the status of the display panel (represented by reference sign LCD) is on, which indicates that the display panel is operating. The first control signal Vcom_vgg is at the high level H to turn on the first switching element Vcom_TFT and the common voltage level Vcom is output from the common electrode line 112 to the common electrode (or touch electrode) Sn. At the mean time the second control signal TP_vgg is at the low level L to turn off the third switching element TP_TFT1. Therefore, the common electrode (or touch electrode) Sn is at the common voltage level Vcom. During the display period, the data signal output portion sends out the data signal DATA to the data line Dy, and the output terminal of the touch sensing signal output portion is floating. The gate line Gx sends out the gate signal to turn on the second switching element Pixel_TFT of the pixel, and thus the data signal DATA is written to the pixel electrode 118. As shown in FIGS. 16B and 17, during the touch period, the status of the display panel (represented by reference sign LCD) is off, which indicates that the display panel stops operating. The first control signal Vcom_vgg is at the low level L to turn off the first switching element Vcom_TFT and the common electrode (or touch electrode) Sn is isolated from the common voltage level Vcom. At the mean time the second control signal TP_vgg is at the high level H to turn on the third switching element TP_TFT1. During the touch period, the touch sensing signal output portion sends out the touch sensing signal TP_Sensing to the data line Dy, and the touch sensing signal TP_Sensing reaches the common electrode (or touch electrode) Sn via the third switching element TP_TFT1 to perform touch sensing operations. At the meantime, the output terminal of the data signal output portion is floating. In addition, the gate line Gx sends out the gate signal to turn off the second switching element Pixel_TFT of the pixel, so that the pixel electrode 118 is floating.

Similar to Embodiments 1 and 2, the first control signal Vcom_vgg and the second control signal TP_vgg don't have to be out of phase completely. The high-level periods of the two signals can be overlapped or not be overlapped. Specifically, the falling (rising) edge of the first control signal Vcom_vgg and the rising (falling) edge of the second control signal TP_vgg can be adjusted earlier or later within a width of 10 pulses of the gate signal.

According to the touch display panel of Embodiment 3 of the disclosure, the fourth switching element of Embodiment 2 can be removed to further lower the manufacturing cost because the output signals form the data signal output portion and the touch sensing signal output portion are directly controlled. Embodiment 3 can achieve effects as the same as Embodiment 2 does.

According to the touch display panels of Embodiments 1 to 3, it is not necessary to transmit the touch sensing signals through the metal wires located on the third metal layer as the conventional art. The problems due to the metal wire made of the third metal layer can be solved. The number of manufacturing steps is decreased, the manufacturing cost is reduced, the aperture ratio is increased, the yield is raised, non-uniform image display is prevented, and signal crosstalk is decreased.

While the disclosure has been described by way of example and in terms of the embodiments, it is to be understood that the disclosure is not limited to the disclosed embodiments. On the contrary, it is intended to cover various modifications and similar arrangements (as would be apparent to those skilled in the art). For example, the disclosure describes the touch panel with a structure where the common electrode is above the pixel electrode, but as long as the equivalent circuit is not changed, the disclosure can be applied to a structure where the pixel electrode is above the common electrode. Therefore, the scope of the appended claims should be accorded the broadest interpretation so as to encompass all such modifications and similar arrangements.

What is claimed is:

1. A touch display panel, comprising:
a common electrode;
a first switching element connected between a voltage line and the common electrode;
a data line transmitting a data signal during a display period and a touch sensing signal during a touch period;
a pixel electrode;
a second switching element connected between the data line and the pixel electrode; and
a third switching element connected between the data line and the common electrode,
wherein during the display period, the first switching element and the second switching element are turned on and the third switching element is turned off, and
during the touch period, the first switching element and the second switching element are turned off and the third switching element is turned on.

2. The touch display panel as claimed in claim 1, wherein the first switching element is controlled by a first control signal and the third switching element is controlled by a second control signal, and
the first control signal and the second control signal are substantially out of phase.

3. The touch display panel as claimed in claim 2, wherein the second switching element is controlled by a gate signal, and
the pulse edge of the first and second control signals can be adjusted earlier or later, and the adjustable range is within a width of 10 pulses of the gate signal.

4. The touch display panel as claimed in claim 1, wherein the second and third switching elements are disposed in the area of the common electrode, and
the first switching element is disposed outside the area of the common electrode and connected to the common electrode via a common electrode line.

5. The touch display panel as claimed in claim 1, further comprises:
a driving chip comprising:
an output terminal connected to the data line;
a data signal buffer storing the data signal;
a touch sensing signal buffer storing the touch sensing signal; and
a switch connecting the data signal buffer with the output end during the display period and connecting the touch sensing signal buffer with the output end during the touch period.

6. The touch display panel as claimed in claim 1, further comprises:
a driving chip and a fourth switching element, wherein the driving chip comprises:
a data signal output terminal connected to the data line for outputting the data signal; and
a touch sensing signal output terminal for outputting the touch sensing signal,
wherein the fourth switching element is connected between the data line and the touch sensing signal output terminal,
during the display period, the fourth switching element is turned off and the data signal output terminal outputs the data signal to the data line, and
during the touch period, the fourth switching element is turned on, the touch sensing signal output terminal outputs the touch sensing signal to the data line via the fourth switching element, and the data signal output terminal is floating.

7. The touch display panel as claimed in claim 6, wherein the first switching element is controlled by a first control signal and the third and fourth switching element are controlled by a second control signal, and
the first control signal and the second control signal are substantially out of phase.

8. The touch display panel as claimed in claim 7, wherein the second switching element is controlled by a gate signal, and
the pulse edge of the first and second control signals can be adjusted earlier or later, and the adjustable range is within a width of 10 pulses of the gate signal.

9. The touch display panel as claimed in claim 6, wherein the second and third switching elements are disposed in the area of the common electrode, and
the first and fourth switching element are disposed outside the area of the common electrode and the first switching element is connected to the common electrode via a common electrode line.

10. The touch display panel as claimed in claim 1, further comprises:
a driving chip comprising:
a data signal output terminal connected to the data line for outputting the data signal; and
a touch sensing signal output terminal for outputting the touch sensing signal,
wherein during the display period, the data signal output terminal outputs the data signal to the data line and the touch sensing signal output terminal is floating, and
during the touch period, the touch sensing signal output terminal outputs the touch sensing signal to the data line and the data signal output terminal is floating.
